(19) United States
(12) Patent Application Publication
(10) Pub. No.: US 2013/0175286 A1
(43) Pub. Date: Jul. 11, 2013

(54) Medication Drawer and Medication Packaging Strip

(71) Applicant: Advantage Pharmacy Services LLC, Madison, MS (US)

(72) Inventors: John Todd Barrett, Madison, MS (US); Fred P. Schoville, Brighton, MI (US)

(73) Assignee: ADVANTAGE PHARMACY SERVICES LLC, Madison, MS (US)

(21) Appl. No.: 13/734,109

(22) Filed: Jan. 4, 2013

Related U.S. Application Data
(60) Provisional application No. 61/583,296, filed on Jan. 5, 2012.

(51) Int. Cl. A61J 1/03

(52) U.S. Cl. CPC A61J 1/035
USPC 221/1; 221/25; 206/462

(57) ABSTRACT

A medication drawer, a related medication packaging strip, and a related method of handling a medication packaging strip.

### CROSS-REFERENCE TO RELATED APPLICATION

This application claims the benefit of U.S. Provisional Application No. 61/583,296, filed Jan. 5, 2012, the content of which is incorporated herein by reference in its entirety.

### TECHNICAL FIELD

The field to which the disclosure generally relates includes medication drawers and related medication packaging strips.

### BACKGROUND

Computerized medication administering cabinets or carts are frequently used in medical care facilities to administer medication to patients on a patient-by-patient basis. For example, such cabinets or carts may include a plurality of drawers or cassettes that hold medication in bulk. But such apparatuses may be prone to tampering and may not be well adapted to releasing prepackaged medication on a packaged dose-by-dose basis.

### BRIEF SUMMARY

The present disclosure is directed to an illustrative embodiment of a medication drawer for a medication cabinet. The drawer includes a housing including a main body, and a front cover coupled to the main body and including a base wall having a packaging strip outlet therethrough. The drawer also includes at least one sensor upstream of the outlet and operatively disposed to sense sensor pickups on a medication packaging strip to be released through the outlet. The drawer further includes a packaging strip guide including at least one guide surface oppositely disposed from the at least one sensor to guide the packaging strip through the outlet and to reflect light to the at least one sensor.

According to another aspect, the present disclosure is directed to an illustrative embodiment of a medication packaging strip. The strip includes a base, a cover over at least a portion of the base, and a plurality of spaced apart tear lines defining a plurality of individual packages each having a leading edge, a trailing edge, and side edges extending between the front and trailing edges, a upper surface, a bottom surface, and at least one sensor pickup located closer to the trailing edge than to the leading edge, and medication disposed between corresponding portions of the cover and the base.

### BRIEF DESCRIPTION OF THE DRAWINGS

Illustrative embodiments of the invention will become more fully understood from the detailed description and the accompanying drawings, wherein:

FIG. 1 is a perspective view of a medication drawer for releasing a strip according to one illustrative embodiment, wherein a first package of a medication packaging strip has been released and a second package of the strip is being released;

FIG. 2 is an exploded perspective view of the drawer of FIG. 1;

FIG. 3 is a rear view of a front cover of the drawer of FIG. 1, including a guide;

FIG. 4 is a rear perspective view of the guide of FIG. 3;

FIG. 5 is another rear perspective view of the guide of FIG. 3;

FIG. 6 is a side view of the guide of FIG. 3;

FIG. 7 is a bottom view of the strip of FIG. 1;

FIG. 8 is an enlarged, fragmentary, sectional side view of a portion of the drawer of FIG. 1, illustrating the strip at a home position relative to an outlet;

FIG. 9 is a rear perspective view of a portion of a medication drawer according to another illustrative embodiment; and

FIG. 10 is a front perspective view of a portion of the drawer of FIG.

9.

### DETAILED DESCRIPTION OF ILLUSTRATIVE EMBODIMENTS

The following description of the embodiment(s) is merely illustrative in nature and is in no way intended to limit the invention, its application, or uses.

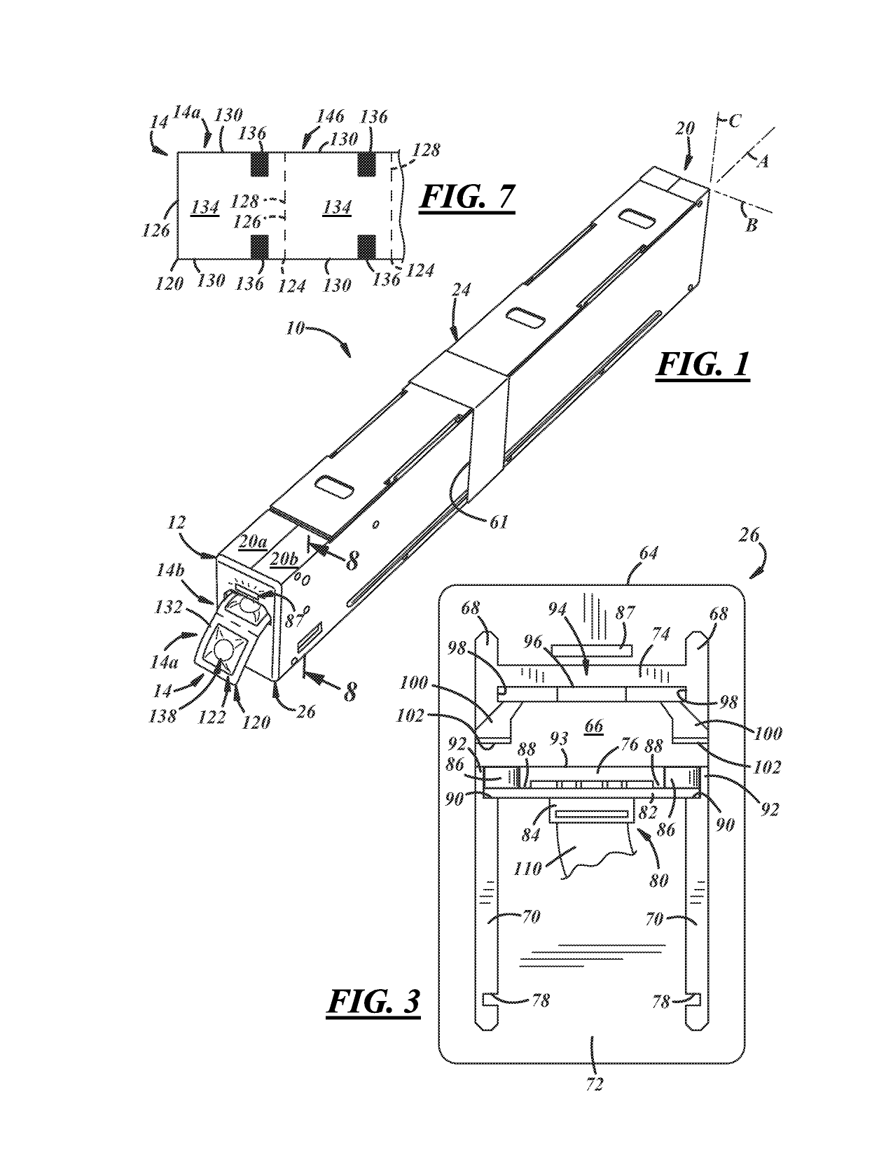

FIGS. 1-3 illustrate an apparatus according to illustrative embodiments. FIG. 1 illustrates a medication cassette or drawer 10, which, according to one embodiment, may be used with a medication cabinet. The terminology medication drawer and medication cassette are used interchangeably herein. The drawer 10 may be just one of a plurality of drawers 10 in a powered and computerized medication cabinet. For example, the disclosure of U.S. Patent Application Publication 2010/0114367 is incorporated herein by reference in its entirety. As used herein, the term “cabinet” may include a stationary cabinet or a mobile cabinet or cart. The drawer 10 may include a longitudinal axis A, a horizontal axis B, and a vertical axis C. The illustrative drawer 10 includes a housing 12 to house a medication packaging strip 14 and provide support for other components of the drawer 10.

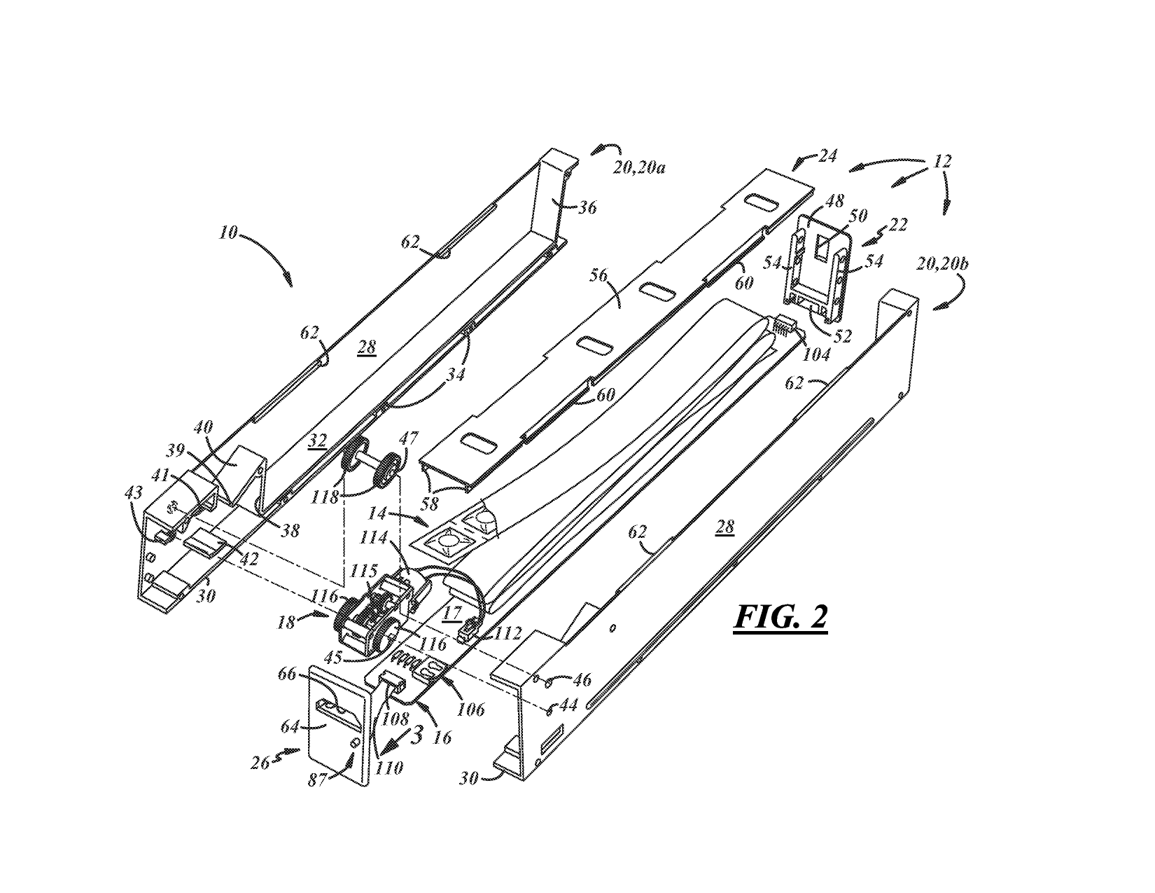

For example, as illustrated in FIG. 2, the housing 12 also may house a circuit board assembly 16 including a circuit board 17, and a material handler 18 of the drawer 10. The housing 12 may include a main body 20 that may be unitary or that may include multiple portions, for example, left and right sides 20a, 20b that may be mirror images of one another and may be fastened, clipped, snap-fit, adhered, and/or coupled together in any other suitable manner. The housing 12 also may include a rear cover 22 that may rearwardly cover the main body 20, a top cover 24 that may cover an upper portion of the main body 20, and a front cover 26 that may frontally cover the main body 20. The housing 12 may be produced in any suitable manner, for example, casting, molding, machining, or the like.

The main body 20 may include sidewalls 28, a bottom wall 30 that may extend between the sidewalls 28, and a bottom compartment wall 32 that may extend between the sidewalls 28 vertically spaced from the bottom wall 30. The main body 20 also may include projections 34 that may extend from the bottom wall 30 toward the bottom compartment wall 32 for retaining the circuit board assembly 16 therebetween, rear and front compartment walls 36, 38 that may extend upwardly from the bottom compartment wall 32 and between the sidewalls 28, and a packaging strip guide wall 40 that may extend between the sidewalls 28 and forwardly from the front compartment wall 38.

The guide wall 40 may extend downwardly at an angle from an upper portion of the front compartment wall 38 and in a direction toward a front of the drawer 10. In another embodiment, the guide wall 40 may extend level or generally parallel to the bottom wall 30. Also, the guide wall 40 may include a leading edge 39 and upstream lower strip guides 41 (FIG. 8) that extend from the leading edge 39 along respective sidewalls 28 to facilitate guiding the strip 14 toward the material handler 18. The main body 20 also may include a material handler support wall 42 that may extend between the sidewalls 28 and may be located between a forward portion of the guide wall 40 and a forward end of the main body 20. Similarly, the main body 20 further may include downstream lower strip guides 43 that may extend from and partially between the sidewalls 28 to facilitate guiding the strip 14 away from the material handler 18. The sidewalls 28 also may include apertures 44, 46 to accept shafts 45, 47 of the material handler 18.

As shown in FIG. 8, strip guides 41 may extend to positions just upstream of where the drive and driven elements 116, 118, and the strip guide 43 may extend from positions just downstream of where the drive and driven elements 116, 118 engage. The strip guides 41 may include upper surfaces 41a to facilitate guiding the strip 14 toward the material handler 18, beveled edges 41b to provide clearance for a lower one of the elements 116, and leading edges 41c therebetween. Similarly, the strip guide 43 may include upper surfaces 43ato facilitate guiding the strip 14 away from the material handler 18, beveled edged 43b to provide clearance for a lower one of the elements 116, and a trailing beveled edge 43c therebetween to provide good guidance for the leading edge 126 of the strip 14. The upper surfaces 41a, 43a may be substantially aligned or flush with upper surfaces of a material handler housing 18a that carries the elements 116. Accordingly, the material handler housing 18a and the upper surfaces 41a, 43a may provide good support for the strip 14.

The rear cover 22 may include a base wall 48 that may have a locking latch aperture 50 and an electrical connector passage 52 therethrough. The rear cover 22 also may include flanges 54 extending from the base wall 48 for coupling to the main body 20 of the housing 12. The rear cover 24 may be may be fastened, clipped, snap-fit, adhered, and/or coupled to the main body 20 in any other suitable manner.

The top cover 24 may include a base wall 56, with flanges 58 and engagement features 60 extending therefrom. The top cover 24 may be coupled to the main body 20 in any suitable manner. For example, the top cover 24 may be clipped to the main body 20 using the engagement features 60 that may engaged corresponding engagement features 62 of the main body 20. The engagement features 62 may be corresponding lips or projections constructed and arranged for interference fit with one another, and may include cooperating geometries suitable for tamper-resistant locking to one another.

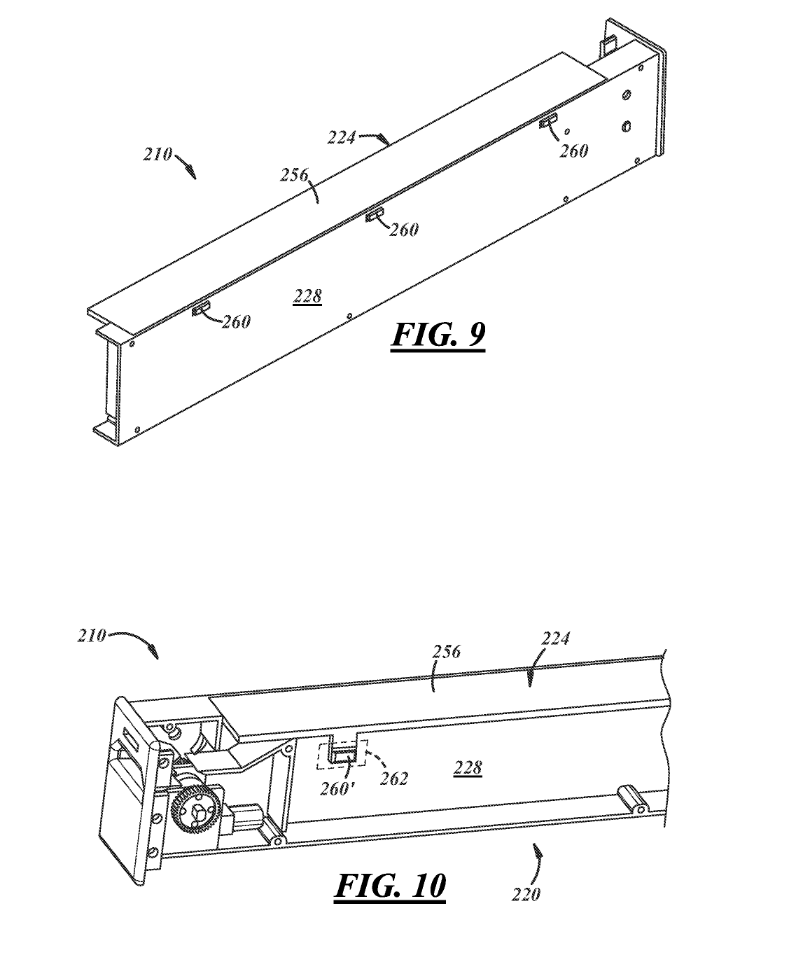

In another embodiment, and with reference to FIGS. 9 and 10, a top cover 224 may have an integral hinge. For example, the top cover 224 may include integral tabs 260 extending along one side of a cover base 256 and a corresponding sidewall 228 may have corresponding slots into which the tabs 260 extend. The tabs 260 may be C-shaped extensions of the cover 224. In this embodiment, another sidewall (not shown) may include an engagement feature 262 such as a slot, tab, ramp, bayonet, or the like, and the top cover 224 also may include another tab 260′ that may extend from the generally planar base wall 256 at a side of the top cover 224 opposite of the integral hinge. Accordingly, the top cover 224 may be closed over the housing body 220 and releasably fastened thereto wherein the top cover tab 260 may engage the corresponding feature 262 of the sidewall 228.

In other embodiments, the drawers 10 may be provided with tamper evident tape 61, as shown in FIG. 1. For example, the tamper evident tape 61 may be wrapped partially or entirely around the drawer 10 around the longitudinal axis A thereof. In other examples, the tape 61 may be applied along seams of the drawer 10.

As best shown in FIG. 3, the front cover 26 may include a base wall 64 with a packaging strip outlet 66 therethrough, and upper and lower vertical flanges 68, 70 extending from a rear surface 72 of the base wall 64 that may be used for coupling to the main body 20. The front cover 26 also may include an upper horizontal flange 74 extending from the rear surface 72 between the upper vertical flanges 68, a lower horizontal flange 76 across the outlet 66 from the upper horizontal flange 74 and extending from the rear surface 72 between the lower vertical flanges 70. The lower vertical flanges 70 may define a slot 78 to receive a front portion of the circuit board assembly 16.

Also, the front cover 26 may carry another circuit board assembly 80 that may include a circuit board 82, a connector 84 coupled to the circuit board 82, and one or more sensors 86 that may be carried by the circuit board 82 upstream of the outlet 66 and may be flush with an upper surface of the lower horizontal flange 76. As used herein, the term “flush” includes substantially level to slightly recessed within typical manufacturing and assembly tolerances. The sensors 86 may include a pair of sensors that are laterally spaced apart along the B axis. The sensors 86 may include OPB710F reflective sensors available from OPTEK Technology Inc. of Carrollton, Tex. In another embodiment, the sensors 86 may be carried by any suitable portion of the drawer 10 so long as the sensors 86 are disposed upstream of the outlet 66.

The circuit board assembly 80 also may include a light 87 that may be electrically coupled to the circuit board 82 in any suitable manner and may extend through a corresponding aperture in the base wall 64 of the front cover 26. The light 87 may include one or more light emitting diodes (LEDs), an LED bar, or any other suitable lighting device(s).

The circuit board 82 may be mounted to the front cover 26, for example, by being positioned between portions of the lower vertical flanges 70 and the lower horizontal flange 76. More specifically, the circuit board 82 may be frictionally engaged by and vertically between legs 88 of the lower horizontal flange 76 and shoulders 90 of the lower vertical flanges 70. Also, the circuit board 82 may be frictionally engaged by and horizontally between extensions 92 of the lower vertical flanges 70. In any case, the sensors 86 may be positioned adjacent to the outlet 66 and operatively disposed in a vertical orientation to sense sensor pickups on a packaging strip to be released out of the outlet 66, for example, for administration to a patient by suitable medical personnel. For instance, upper surfaces of the sensors 86 may be flush with upper surfaces 93 of the front cover 26 at the opening 66 thereof.

Further, the front cover 26 may include a packaging strip restraint or guide 94. The guide 94 may be a separate component carried by the front cover 26 or may be integral with the front cover 26. The guide 94 may include a base wall 96 that may be carried in a corresponding slot 98 that may be defined by the upper vertical flanges 68 adjacent the upper horizontal flange 74.

The guide 94 also may include legs 100 extending from the base wall 96. The legs 100 may extend outwardly at an angle, for example, about 45 degrees, for instance, 30 to 60 degrees. Accordingly, the legs 100 may extend outboard of the lateral extent of the base wall 96.

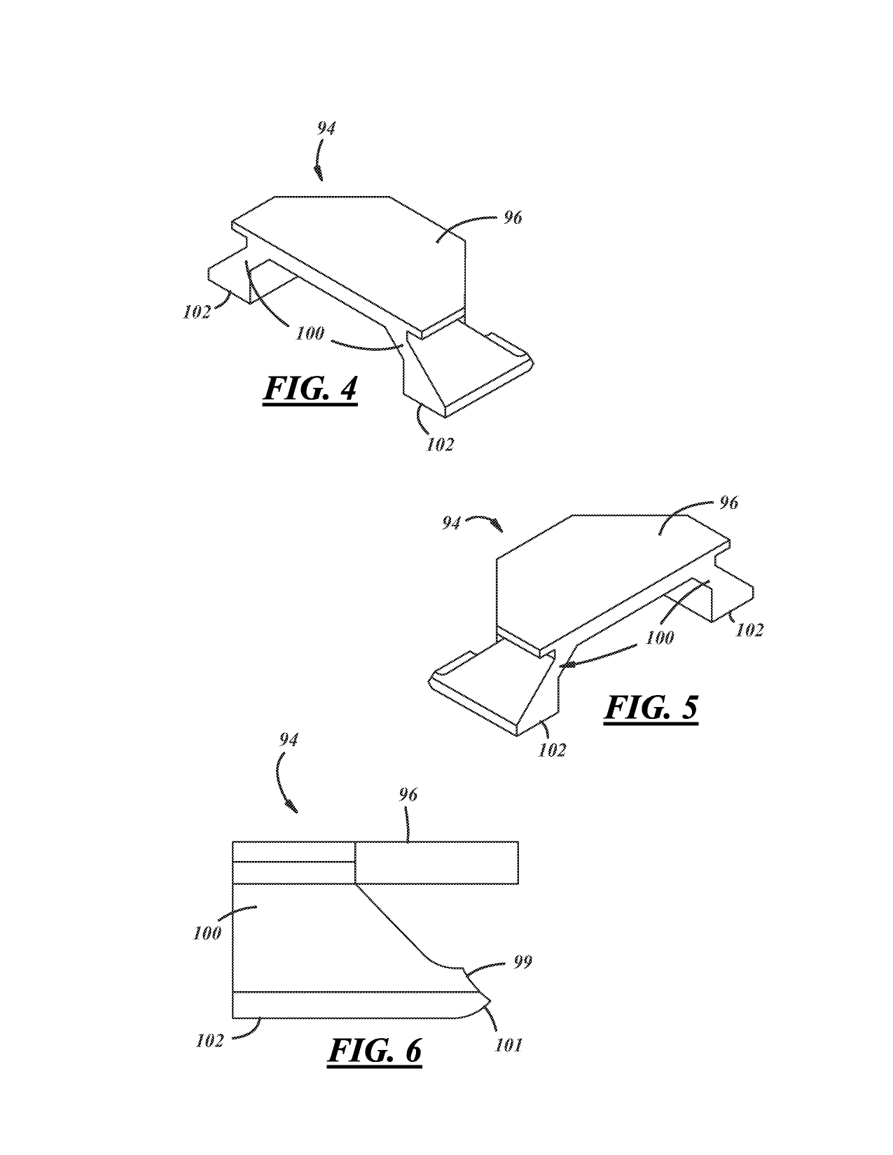

As also shown in FIGS. 4 and 5, the legs 100 may have guide surfaces 102 oppositely disposed from the sensors 86 across the outlet 66 to guide the packaging strip 14 to be released out of the outlet 66 and to serve as reflectors to the sensors 86. The guide surfaces 102 may be flat and rectangular with widths extending along the B axis and lengths extending along the C axis. The guide surfaces 102 also may generally extend in a plane parallel to the B axis and normal to the C axis, and may be positioned and sized to overlap the sensors 86.

As also shown in FIG. 6, the legs 100 also may include first rear surfaces 99 and second rear surfaces 101 that may be beveled to provide good guidance for the strip 14. The second rear surfaces 101 may be disposed between the first rear surfaces 99 and the guide surfaces 102.

Accordingly, in one embodiment, at least the guide surfaces 102 may be reflectors to reflect light to the sensors 86. For example, the guide 94 may be composed of a white plastic. For example, the guide 94 may be composed of an engineering plastic, for instance an acetal plastic, a NYLON plastic, or the like. The guide 94 may be formed in any suitable manner, for example in a die and including a white dye, for instance, PANTONE Bright White 11-0601 TC. Accordingly, the guide surfaces 102 may be sufficiently smooth and bright to provide good reflection for sensor activation.

Referring to FIG. 2, the circuit board assembly 16 also may include an electrical connector 104 that may be coupled to the circuit board 17 in any suitable manner and that may at least partially pass through the connector passage 52 of the rear cover 22. The connector 104 may engage a corresponding electrical connector of the apparatus in which the drawer 10 is used. For example, the connector 104 may be configured for coupling to an electrical backplane (not shown) of such an apparatus. The circuit board assembly 16 also may include a memory device 106 that may be disposed at a front end of the circuit board 17, a connector 108 and associated wires 110 coupled to the front end of the circuit board 17 and to the other circuit board assembly 80 carried by the front cover 26, and a motor wire connector 112 coupled to the circuit board 17 and to the material handler 18.

The material handler 18 may be carried by the housing 12 in any suitable manner for movement of medication out of the housing 12. For example, the material handler 18 may be supported by the material handler wall 42 and between the sidewalls 28 of the main body 20 so as to feed or convey the packaged medication strip 14 out of the housing 12 through the outlet 66. The material handler 18 may include a powertrain including a prime mover 114. The prime mover 114 may be an electrical motor or any other suitable device. The powertrain also may include a drivetrain coupled to the prime mover or motor 114 in any suitable manner. The drivetrain may include a transmission 115 having its input coupled to the motor 114 and drive elements 116 coupled to the output shaft 45 to drive the strip 14. The drive elements 116 may be toothed wheels or gears, or other meshing elements, or any other suitable drive elements. The material handler 18 also may include driven elements 118 on the driven shaft 47 on a side of the medication packaging strip 14 opposite that of the drive elements 116. The driven elements may be toothed wheels or gears, or other meshing elements, or any other suitable driven elements. In one embodiment, the drive and driven elements 116, 118 may include gears each having a 48 diametral pitch, forty-four teeth, and 14.5 pressure angle and that are available as part number A 1N 2-N48044 from Stock Drive Products/Sterling Instrument of New Hyde Park, N.Y. In any case, it is preferable that the gears have no less than twenty-two teeth.

The medication packaging strip 14 may be rolled or folded back onto itself in a compact manner within the housing 12 as illustrated, or may be wound on a spool or reel, or the like. As used herein, the term medication may include anything for topical treatment or internal care of patients and in any form, including but not limited to solids, liquids, powders, gels, creams, lotions, ointments, syringes, sprays or sprayers, bandages, gauze, or any other supplies.

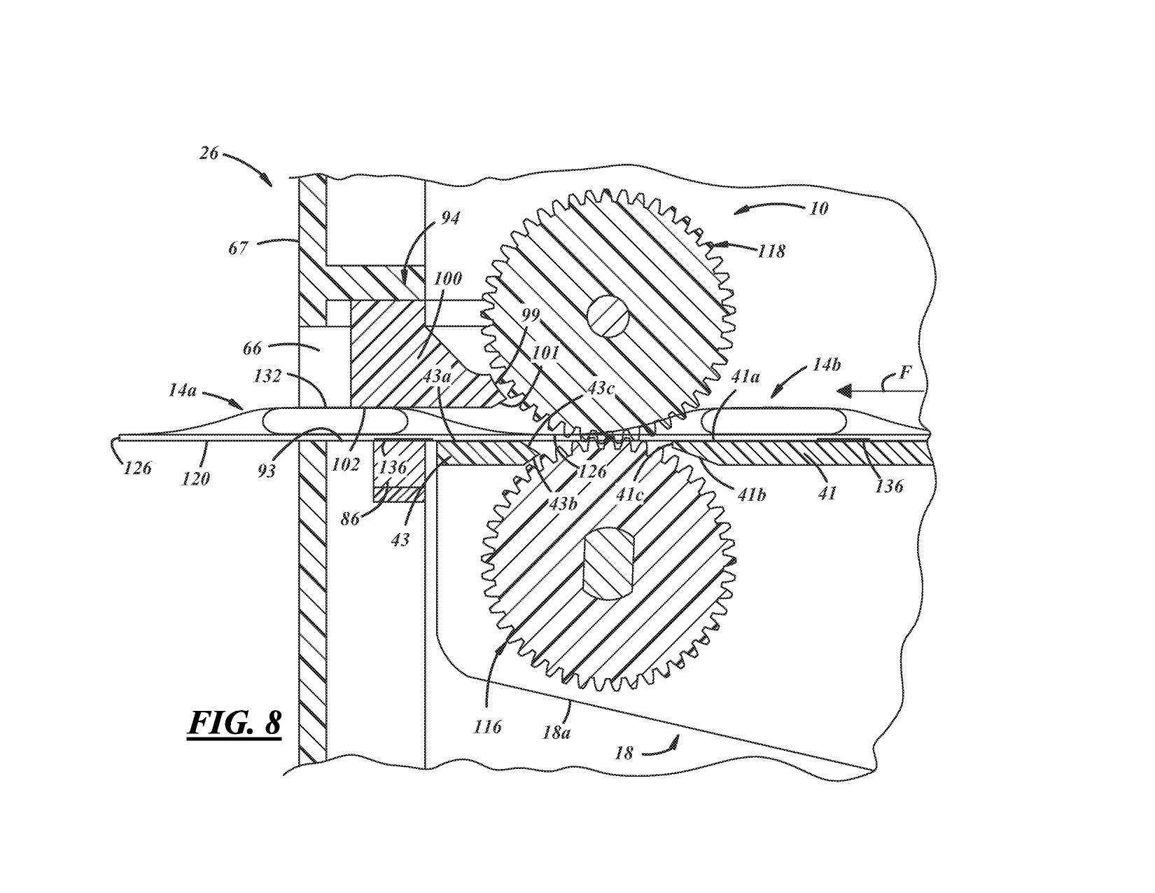

Referring to FIGS. 1 and 7, the strip 14 may include a base 120, and a cover 122 over at least a portion of the base 120. As best shown in FIG. 7, the strip 14 also may include a plurality of spaced apart tear lines 124 defining a plurality of individual packages 14a, 14b each of which may have a leading edge 126, a trailing edge 128, and side edges 130 extending between the front and trailing edges 126, 128. The tear lines 124 may be predefined by perforations, weakenings, thinnings, frangible connectors, or any other suitable features. Each individual package 14a, 14b also may have an upper surface 132 (FIG. 1), and a bottom surface 134.

In one embodiment, the bottom surfaces 134 may be reflective surfaces with one or more sensor pickups 136. For example, the bottom surfaces 134 may be white for good reflectivity and the pickups 136 may be black for good contrast. Like the guide surfaces, the bottom surfaces 134 may be sufficiently smooth and bright to provide good reflection for sensor activation. In fact, the white guide surfaces and the white bottom surfaces 134 may be colored so as to mimic reflectivity of one another.

The pickups 136 may be located in any suitable location along the length of the packages. However, it is preferred that the location, in conjunction with the location of the sensors 86, the guide 94, and the elements 116, 118 of the drawer 10, prevents any given package from extending out of the outlet 66 or so near the outlet 66 so as to enable tampering, yet ensures that the leading edge of the strip is properly guided toward the outlet 66. For example, the sensor pickups 136 may be located closer to the trailing edges 128 than to the leading edges 126. Also, the size of the pickups 136 may correspond to the size of the sensors 86. For example, the width of the pickups 136 in a feed direction of the strip 14 may be the same as the diameter of the active portions of the sensors 86 within plus or minus 15%. As illustrated, the sensor pickups 136 may include a pair of laterally spaced apart sensor pickups at the opposed sided edges 130. In another embodiment, however, only one sensor pickup may be used and may be located along one of the side edges or laterally between the side edges of the packages. In a further embodiment, the pickups 136 may be located on the top surfaces 134 of the strip 14. Of course, the location of the guide 94 and the sensors 86 likewise may be reversed. For example, the guide 94 may be provided beneath the sensors 86 such that the guide surfaces face up and the sensors 86 may be disposed above the guide surfaces 102. Such reversals of parts would be obvious to one of ordinary skill in the art.

Each individual package 14a, 14b also may have a dose of medication 138 (FIG. 1) disposed between corresponding portions of the cover 122 and the base 120. As used herein, the term “dose” may include one or more individual tablets, capsules, or the like.

In operation, with the drawer 10 removed from its corresponding medication cabinet, and with the top cover 24 removed from the main body 20, the strip 14 may be loaded into its compartment in the drawer 10. The strip 14 may be loaded so that a leading edge of the strip 14 is fed between the drive and driven elements 116, 118 and advanced to a home position. For example, as shown in FIG. 8, the home position of the strip 14 can include any leading edge 126 of the strip 14 advanced through the driven elements 116, 118 to a position just downstream thereof. For instance, the leading edge 126 of the second package 14b is in a position downstream of the driven elements 116, 118. When the strip 14 is first loaded to the drawer 10, the leading edge of the first package 14a of the strip 14 may be advanced to the position just downstream of the driven elements 116, 118.

In one embodiment, the strip 14 may be advanced automatically, for example, by connecting the connector 104 of the drawer 10 to a powered loading station, which may provide power to the motor 114 and the sensors 86 and may control operation of the motor 114 to allow an operator to continuously or stepwise advance the motor 114. In another embodiment, the strip 14 may be advanced manually, for example, by removing or raising the driven elements 118, placing the strip 14 in position, and repositioning the driven elements 118. Once the strip 14 is loaded and advanced to its home position, the top cover 24 may be coupled to the main body 20 and the drawer 10 assembled to its corresponding slot in the medication cabinet so that the connector 104 connects to its corresponding electrical connector of the medication cabinet.

Thereafter, the strip 14 may be released from the drawer 10 on a unit dose, unit-of-use, or dose-by-dose basis. For example, an operator may use any suitable input device to instruct a controller to power the motor 114 to advance the leading individual package of the strip 14 in a downstream direction out of the outlet 66. As the strip 14 is advanced downstream, the sensors 86 sense the absence of the pickups 136 by way of the reflective guide surfaces 102 of the packaging strip guide 94, and then by way of the white surfaces of the packaging strip.

The motor 114 will continue to operate until the sensor pickups 136 on the leading package 14a of the strip 14 align with the sensors 86 wherein the sensors 86 sense the presence of the pickups 136. At this point, the controller receives signals (e.g. binary “1”) from the sensors 86 and depowers the motor 114 in response thereto.

For instance, FIG. 8 illustrates a corresponding position of the package 14a relative to the sensors 86. At that point, a suitable portion of the first package 14a projects beyond the front cover 26 to allow a user to grasp the package 14a, and pull and tear the package 14a away from the second package 14b. When the first package 14a has been removed, the sensors 86 sense the absence of the pickups 136 by way of the reflective surfaces 102 provided by the guide 94. At this point, the controller receives signals (e.g. binary “0”) from the sensors 86 and maintains the motor 114 in a depowered state. Accordingly, once the leading package is removed, the leading edge 126 of the subsequent package is positioned just downstream of the driven elements 116, 118 but sufficiently far upstream of the front surface 67 of the front cover 26 and the outlet 66 to prevent someone from pulling the strip 14 out of the outlet 66 using their fingers. In fact, the release position may include the leading edge of the subsequent package being disposed upstream of the sensors 86, as shown in FIG. 8.

Again, a user may use a suitable input device to instruct the controller to power the motor 114 to advance the subsequent individual package of the strip 14 toward and out of the outlet 66. Again, the sensors 86 sense the absence of the pickups 136 by way of the reflective surfaces 102 provided by the guide 94 wherein the controller receives signals (e.g. binary “0”) from the sensors 86 and maintains the motor 114 in a powered state. Therefore, the motor 114 will continue to operate until the sensor pickups 136 on the subsequent package 14b of the strip 14 align with the sensors 86 wherein the sensors 86 sense the presence of the pickups 136. At this point, the controller receives signals (e.g. binary “1”) from the sensors 86 and depowers the motor 114 in response thereto.

As the controller powers the motor 114, the controller also powers the light 87 to indicate which drawer(s) of a plurality of drawers 10 in a medication cabinet are releasing medication. For example, the controller may power the light 87 in a steady or blinking manner to alert an operator as to which drawer should be releasing one or more packages of the strip 14.

In one embodiment, the sensors 86 may operate as part of a medication counter so that the quantity of medication doses that passes through the outlet 66 can be counted. For example, each time the leading individual package of the strip 14 is advanced through the outlet 66, the sensors 86 sense the pickups 136 and the controller may receive a corresponding indication from the sensors 86 that may be used to increment a counter in the controller to track the quantity of individual packages that have been advanced or released. In another example, each time the leading individual package of the strip 14 is removed from the rest of the strip 14 through the outlet 66, the sensors 86 sense the absence of the pickups 136 and the controller may receive a corresponding indication from the sensors 86 that may be used to increment a counter in the controller to track the quantity of individual packages that have been released.

Also, although not shown, the motor 114 may include a drive worm on an output shaft that is coupled to an input gear of the transmission 115. The drive worm may drive the input gear but the opposite is not true, so as to provide unidirectional operation and a locking feature to prevent someone from pulling the medication packaging strip 14 through the outlet 66. Accordingly, once the powertrain stops, the drivetrain locks to prevent tampering with the drawer 10. Therefore, any attempt to pull an outlet-advanced leading package to pull more than one package of the strip through the outlet will simply result in tearing away of the leading package from the subsequent package.

As used in the sections above and claims below, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components, elements, or items. Similarly, when introducing elements of the invention or the example embodiments thereof, the articles “a,” “an,” “the,” and “said” are intended to mean that there are one or more of the elements. Moreover, directional words such as front, rear, top, bottom, upper, lower, radial, circumferential, axial, lateral, longitudinal, vertical, horizontal, transverse, and/or the like are employed by way of description and not limitation. Other terms are to be construed using their broadest reasonable meaning unless they are used in a context that requires a different interpretation.

Finally, the foregoing description is not a definition of the invention, but is a description of one or more examples of exemplary embodiments of the invention. The statements contained in the foregoing description relate to the particular examples and are not to be construed as limitations on the scope of the invention as claimed below or on the definition of terminology used in the claims, except where terminology is expressly defined above. And although the present invention has been disclosed using a limited number of examples, many other examples are possible and it is not intended herein to mention all of the possible manifestations of the invention. In fact, other modifications, variations, forms, ramifications, substitutions, and/or equivalents will become apparent to those skilled in the art in view of the foregoing description. The present invention is intended to embrace such forms, ramifications, modifications, variations, substitutions, and/or equivalents as fall within the spirit and broad scope of the following claims. In other words, the present invention encompasses many substitutions or equivalents of limitations recited in the following claims. For example, the materials, sizes, and shapes, described above could be readily modified or substituted with other similar materials, sizes, shapes, and/or the like. Therefore, the invention is not limited to the particular examples of exemplary embodiments disclosed herein, but instead is defined solely by the claims below.

What is claimed is:

1. A medication drawer, comprising:
a housing including a main body, and a front cover coupled to the main body and having a base wall with a packaging strip outlet therethrough;
at least one sensor disposed upstream of the outlet and operatively disposed to sense at least one sensor pickup on a medication packaging strip to be released through the outlet; and
a packaging strip guide including at least one guide surface oppositely disposed from the at least one sensor to guide the packaging strip through the outlet and to reflect light to the at least one sensor.

2. The medication drawer of claim 1, further comprising a circuit board assembly including a circuit board carrying the at least one sensor and being mounted to the front cover.

3. The medication drawer of claim 2, wherein the front cover also includes vertical flanges extending from a rear surface of the base wall of the front cover and a horizontal flange extending from the rear surface of the base wall of the front cover between the vertical flanges and across the outlet from the guide, wherein the at least one sensor is flush with a upper surface of the horizontal flange.

4. The medication drawer of claim 2, wherein the circuit board assembly also includes a light.

5. The medication drawer of claim 1, further comprising a material handler carried by the housing to convey the packaging strip out of the housing, and including a prime mover, a transmission coupled to the prime mover, laterally spaced drive elements coupled to the transmission, and laterally spaced driven elements operatively coupled to the drive elements, wherein the prime mover drives the transmission and the transmission drives the drive elements and the drive elements engage the packaging strip against the driven elements to convey the packaging strip in a direction toward the outlet.

6. The medication drawer of claim 5, wherein the drive and driven elements include gears having at least twenty-two teeth.

7. The medication drawer of claim 6, wherein the gears have forty-four teeth.

8. The medication drawer of claim 5, wherein the material handler advances the packaging strip to a release position of the packaging strip where the at least one sensor pickup on the packaging strip aligns with the at least one sensor so that a leading edge of a leading package of the packaging strip is outboard of an outer surface of the front cover and so that a leading edge of a subsequent package connected to the leading package is inboard of an outer surface of the front cover.

9. The medication drawer of claim 5, wherein the release position includes the leading edge of the subsequent package being disposed upstream of the at least one sensor.

10. The medication drawer of claim 1, wherein the packaging strip guide is a component separate from the front cover and carried by the front cover.

11. The medication drawer of claim 10, wherein the guide includes a base wall carried in a corresponding slot of the front cover, and legs extending from the base wall and terminating in the at least one guide surface.

12. The medication drawer of claim 1, wherein the packaging strip guide is composed of a die molded engineering plastic including a white dye for reflectivity.

13. The medication drawer of claim 1, wherein the front cover carries a light to indicate when the packaging strip is being released.

14. The medication drawer of claim 1 further comprising:
a material handler carried by the housing to convey the packaging strip out of the housing and including a material handler housing carrying at least one driven element;
at least one driven element carried by the housing and driven by the at least one drive element;
wherein the housing also includes strip guides extending to positions just upstream of engagement between the drive and driven elements, and other strip guides extending from positions just downstream of engagement between the drive and driven elements.

15. The medication drawer of claim 1 wherein the strip guides include upper surfaces to facilitate guiding the strip toward and away from the material handler and substantially aligned with upper surfaces of the material handler housing to support the strip.

16. The medication drawer of claim 1, further comprising:
a material handler carried by the housing to convey the packaging strip out of the housing, and including at least one drive element and at least one driven element operatively coupled to the at least one drive element, wherein the packaging strip is engaged by the drive and driven elements which are powered by a prime mover to convey the packaging strip in a direction toward the outlet;
wherein the prime mover and drive and driven elements advance the strip out of the outlet until the at least one sensor senses the at least one sensor pickup on the strip for depowering the prime mover, such that a portion of the strip projects out of the outlet to allow a user to grasp the strip, and pull and tear an individual package away from the rest of the strip.

17. The medication drawer of claim 16, wherein when the individual package has been removed, the at least one sensor senses the absence of the at least one sensor pickup by way of the at least one reflector of the packaging strip guide for maintaining the prime mover in a depowered state.

18. The medication drawer of claim 17, wherein once the individual package is removed from the rest of the strip, a leading edge of a subsequent package is positioned downstream of the drive and driven elements but upstream of the outlet to prevent pulling of the strip out of the outlet with fingers.

19. A medication packaging strip, comprising
a base;
a cover over at least a portion of the base; and
a plurality of spaced apart tear lines defining a plurality of individual packages each having a leading edge, a trailing edge, and side edges extending between the front and trailing edges, a upper surface, a bottom surface, and at least one sensor pickup located closer to the trailing edge than to the leading edge, and a dose of medication disposed between corresponding portions of the cover and the base.

20. The medication packaging strip of claim 19, wherein the at least one sensor pickup includes a pair of laterally spaced apart sensor pickups at opposite side edges.

21. A method of handling a medication packaging strip, comprising:
providing a housing including a main body and a front cover coupled to the main body and having a base wall with a packaging strip outlet therethrough;
providing at least one sensor upstream of the outlet and operatively disposed to sense at least one sensor pickup on a medication packaging strip to be released out of the outlet;
providing a packaging strip guide including at least one guide surface oppositely disposed from the at least one sensor to guide the packaging strip through the outlet and to reflect light to the at least one sensor;
sensing the absence of the at least one sensor pickup by way of the at least one guide surface of the packaging strip guide for maintaining the prime mover in one of a powered or depowered state; and
conveying the packaging strip out of the housing using a prime mover, at least one drive element, and at least one driven element operatively coupled to the at least one drive element, wherein the packaging strip is engaged by the drive and driven elements which are powered by the prime mover to convey the packaging strip in a direction toward the outlet until the at least one sensor senses the at least one sensor pickup.

22. The method of claim 21, further comprising sensing with the at least one sensor, the at least one sensor pickup on the strip for depowering the prime mover such that a portion of the strip projects out of the outlet to allow a user to grasp the strip, and pull and tear an individual package away from the rest of the strip.

23. The method of claim 22, further comprising, when the individual package has been removed, sensing the absence of the at least one sensor pickup by way of the at least one reflector of the packaging strip guide for maintaining the prime mover in a depowered state.

24. The method of claim 23, wherein once the individual package is removed from the rest of the strip, a leading edge of a subsequent package is positioned downstream of the drive and driven elements but upstream of the outlet to prevent pulling of the strip out of the outlet with fingers.
